(19) United States
(12) Patent Application Publication
(10) Pub. No.: US 2010/0115596 A1
(43) Pub. Date: May 6, 2010

(54) Method and System for Creating and Sharing Bookmarks of Media Content

(75) Inventors: Tzvetan T. Horozov, Hoffman Estates, IL (US); Nitya Narasimhan, Lake Zurich, IL (US); Venugopal Vasudevan, Palatine, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/262,504

(22) Filed: Oct. 31, 2008

(51) Int. Cl. G06F 17/00; H04L 9/32; G06F 21/00

(52) U.S. Cl. 726/7; 715/206

(57) ABSTRACT

A method for facilitating a bookmark server to create a bookmark from content associated with a content source is disclosed. The method comprises a remote device selecting a portion of the content associated with the content source, based on an input received via a user interface. The remote device then generates metadata associated with the selected portion of the content. The metadata includes information pertaining to the content source and the content. The remote device communicates with the bookmark server, which can access the content associated with the content source. The remote device sends the metadata to the bookmark server along with a request message to the bookmark server to create the bookmark based on the metadata.

### FIELD OF THE DISCLOSURE

The present disclosure relates generally to the field of media content publishing, and specifically relates to a technique for creating and sharing bookmarks of the media content.

### BACKGROUND

With the advent of advanced techniques in the field of electronics and communication, media and entertainment industry has taken a giant leap. With the use of modern technology, the media and entertainment industry has increased its reach by many folds. Today, it is possible to share media content remotely using communication networks such as the Internet. Web-based media publishing services, like YouTube™ and Metacafe™, have gained tremendous popularity. People use such services to post a clip of their desired media content and share that with other people.

Most of the media content is extracted from television (TV) programs, thus violating the copyright protection of the TV content. Such violation is considered illegal. Moreover, though sharing the TV content using the media publishing services may help in promoting the respective TV program, it does not help in increasing subscribers for the channel having broadcast rights of the respective TV program. For example, a user may post a clip of a famous show broadcasted by a particular channel. Another user may be interested in viewing the full content of that famous show after watching the clip, but the clip contains no information regarding the channel and its subscription.

One of the existing techniques for controlling access rights of the content is by determining whether the content is purchased or not. When an access device decides to access the content, a request is received at a content delivery platform. The request is intercepted at a URL proxy, which determines if the content has been purchased or not. If the content has been purchased, the request is redirected to a digital rights server. The digital rights server processes the request and determines digital rights for the content. The digital rights are then provided such that the access device can access the content. If a user of the access device has not already purchased the content, a message may be sent to the access device requesting that the user purchase the content. Once the content is purchased, the digital rights are then provided such that the access device can access the content. The present technique does not focus on creating content clips from a program. It covers an idea of validating a user access to the content, and if denied, then presenting user with option to purchase the content.

In another existing technique, an editing device accesses a media program and a user of the editing device designates excerpts within the media program. Then, bookmarks are generated for the designated excerpts. The bookmarks are transmitted via a network from the editing device to a playback device. By reference to the received bookmarks, the playback device presents an edited version of the media program that includes only the designated excerpts. This technique discloses creation of desired excerpts or clip of the media program, but it does not address issues relating copyright protection of the media program.

Therefore, there exists a need for a method and a system for creating bookmarks of media content and sharing the bookmarks with others, maintaining the copyright protection of the content by controlling access rights of the bookmarks.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 is a system diagram for creating and sharing bookmarks of media content in accordance with some embodiments.

FIG. 2 is a block diagram illustrating components of a bookmark server in accordance with some embodiments.

FIG. 3 is a block diagram illustrating a module included in the bookmark server of FIG. 2 in accordance with some embodiments.

FIG. 4 is a flowchart illustrating a method for facilitating a remote device to send metadata to create a bookmark in accordance with some embodiments.

FIG. 5 is a flowchart illustrating a method for facilitating a bookmark server to create a bookmark in accordance with some embodiments.

FIG. 6 is a flowchart illustrating a method for accessing a bookmark published on a bookmark server in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

Before describing in detail embodiments that are in accordance with the present disclosure, it should be observed that the embodiments reside primarily in combinations of method steps and apparatus components related to creating and sharing bookmarks of media content. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the disclosure described herein may be comprised of one or more conventional processors and unique stored program instructions that control the one or more processors to implement, in conjunction with certain non-processor circuits, some, most, or all of the functions for creating and sharing bookmarks of media content described herein. The non-processor circuits may include, but are not limited to, a radio receiver, a radio transmitter, signal drivers, clock circuits, power source circuits, and user input devices. As such, these functions may be interpreted as steps of a method for creating and sharing bookmarks of media content. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

All of the embodiments described in this Detailed Description are exemplary embodiments provided to enable persons skilled in the art to make or use the disclosure and not to limit the scope of the disclosure, which is defined by the claims.

The present disclosure is directed towards a method for facilitating a bookmark server to create a bookmark from content associated with a content source. In one embodiment, based on an input received via an input interface, a device that receives the content from the content source selects a portion of the content associated with the content source. The device then generates metadata associated with the selected portion of the content. The metadata can include information such as timing, content description, etc. The device communicates with the bookmark server, thereby requesting the bookmark server to create the bookmark. The device sends the metadata to the bookmark server to enable the bookmark server to create the bookmark. The bookmark server has access to the content associated with the content source. The bookmark server creates the bookmark including the metadata and optionally the associated content. The bookmark server controls access rights associated with the metadata and the content associated with the bookmark.

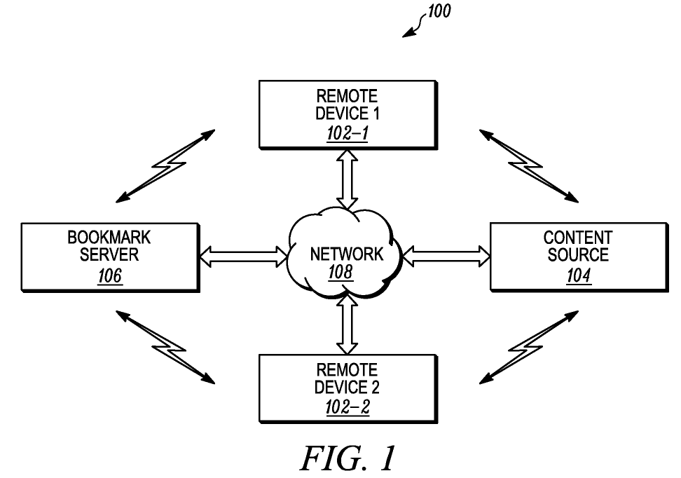

FIG. 1 shows a system 100 for creating and sharing a bookmark of media content. In one embodiment, the system 100 includes two remote devices 102-1 and 102-2, collectively referred to as remote devices 102, a content source 104, a bookmark server 106, and a network 108. The remote devices 102 are electronic devices such as television, set top box, cellular phone, and the like. The remote devices 102 obtain media content from the content source 104. The content source 104 either refer to a pre-recorded audio-video source such as cassette, Compact Disc (CD), Digital Video Disc (DVD), etc., or to broadcast channels broadcasting the media content. The media content includes, but not limited to, pre-recorded music, movies, streaming audio programs, streaming video programs, and images. The bookmark server 106 is any server having capabilities of processing data received from the remote devices 102 and the content source 104. The network 108 is any wired or wireless network and may include various network devices such as routers, switches, bridges, multiplexers, de-multiplexers, repeaters, etc. The network 108 can also refer to the Internet. The remote devices 102, the content source 104, and the bookmark server 106 communicates with each other via the network 108.

In one embodiment, the remote device 102-1 receives the media content from the content source 104, which is a broadcast channel. The media content can be a TV program viewed by a user on the remote device 102-1, which is a television with a set top box. The user provides an input to the remote device 102-1, directing the remote device 102-1 to select a desired portion of the TV program. After selecting the desired program, the remote device 102-1 generates metadata for the selected portion of the TV program. The metadata includes information about the TV program. The remote device 102-1 communicates with the bookmark server 106 via the network 108. The remote device 102-1 sends the metadata to the bookmark server 106 and requests the bookmark server 106 to create a bookmark based on the metadata.

The bookmark server 106 reads the metadata and determines the information about the selected portion of the TV program. Then, the bookmark server 106 accesses the content source 104 to obtain the selected portion of the TV program. The bookmark server 106 creates the bookmark including the metadata and optionally the selected portion of the TV program. In an alternate embodiment, the bookmark server 106 may include a link to the selected portion of the TV program instead of including the portion itself in the bookmark.

After creating the bookmark, the bookmark server 106 publishes the bookmark to enable users subscribed to the bookmark server 106 to access the bookmark. The bookmark server 106 protects the copyright of the TV program by restricting the access to the selected portion of the content. The bookmark server 106 also provides several options to the subscribed users for accessing the TV program from alternative content sources or searching for similar TV programs.

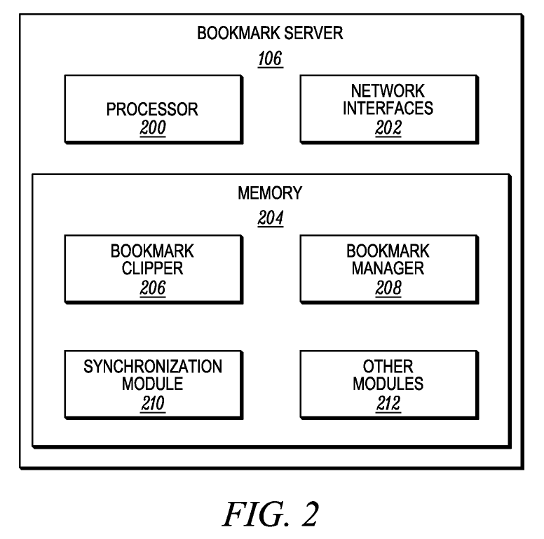

FIG. 2 is a block diagram illustrating various components of the bookmark server 106. The functionality of the bookmark server 106 is explained with respect to various modules depicted in the block diagram. It is to be understood that the various modules are shown to facilitate better understanding of the bookmark server 106. However, the modules included in the bookmark server 106 are not meant to be a limitation on an embodiment of the present disclosure. The following description of the bookmark server 106 has been explained with reference to components shown in FIG. 1. In one embodiment, the bookmark server 106 includes a processor 200, network interfaces 202 for establishing communication with at least one of the remote devices 102, the content source 104, and other devices connected to and included in the network 108, and a memory 204 for storing operating instructions that are executed by the processor 200.

The processor 200 includes one or more microprocessors, microcontrollers, DSPs (Digital Signal Processors), state machines, logic circuitry, or any other device or devices that process information based on operational or programming instructions. Such operational or programming instructions are stored in the memory 204. The memory 204 can be an IC (Integrated Circuit) memory chip containing any form of RAM (Random Access Memory) or ROM (Read-Only Memory), a floppy disk, a CD-ROM (Compact Disk Read-Only Memory), a hard disk drive, a DVD (Digital Video Disc), a flash memory card or any other medium suitable for storing digital information. One of ordinary skill in the art will recognize that when the processor 200 has one or more of its functions performed by a state machine or logic circuitry, the memory 204 containing the corresponding operational instructions can be embedded within the state machine or logic circuitry.

The memory 204 includes various modules for enabling the bookmark server 106 to create and publish bookmarks. In one embodiment, the memory 204 includes a bookmark clipper 206, a bookmark manager 208, a synchronization module 210, and other modules 212 such as an operating system, application support software, etc. that are required for proper functioning of the bookmark server 106.

The bookmark clipper 206 processes metadata received via the network interfaces 202 from a remote device, for example, the remote device 102-1. The bookmark clipper 206 reads the metadata, which includes information such as content source of the content associated with the metadata, Electronic Programming Guide (EPG) information of the content, start time of a portion of the content, duration of the portion of the content, and the like. By analyzing the metadata, the bookmark clipper 206 identifies the portion of the content by accessing the respective content source, for example, the content source 104. The bookmark clipper 206 also determines the type of the content source 104, i.e. whether the content source 104 is a pre-recorded audio-video source or a broadcast channel.

In case, the content source 104 is a pre-recorded audio-video source such as a CD or a DVD, the bookmark clipper 206 searches a database to find the corresponding content of the audio-video source. For example, if the content source 104 is a DVD of the movie “Jurassic park”, the bookmark clipper 206 looks for an availability of the movie in its database, which may be included in the other modules 212. If the bookmark clipper 206 is unable to find a match for the content source 104, the bookmark clipper 206 passes the metadata to the bookmark manager 208, which is explained later. However, if the bookmark clipper 206 finds a match, then the bookmark clipper 206 extracts the relevant portion of the movie, as identified by the start time and the duration of the portion of the content included in the metadata.

In another case, where the content source 104 is a broadcast channel broadcasting a program to several devices subscribed to it, the bookmark clipper 206 identifies the portion of the content by accessing the program broadcasted by the broadcast channel. In one embodiment, the bookmark server 106 has subscription for all the broadcast channels operating in a geographical area. Moreover, the bookmark server 106 stores each program currently broadcasted by the broadcast channels in a buffer. The bookmark server 106 may delete a stored program, if the bookmark server 106 receives no request for creating a bookmark by the end of the respective program. The bookmark clipper 206 extracts the relevant portion of the program, as determined by the start time and the duration provided in the metadata. Extracting the relevant portion of the program from the broadcast channel may have some synchronization issues, which are dealt by the synchronization module 210 as explained later.

After identifying and extracting the portion of the content from the content source 104, the bookmark clipper 206 creates a bookmark including the metadata. The bookmark may also include the extracted portion of the content in the bookmark. In another embodiment, the bookmark clipper 206 provides a link to the extracted portion of the content in the bookmark, instead of including the portion of the content itself. After creating the bookmark, the bookmark clipper 206 informs the bookmark manager 208 about the created bookmark.

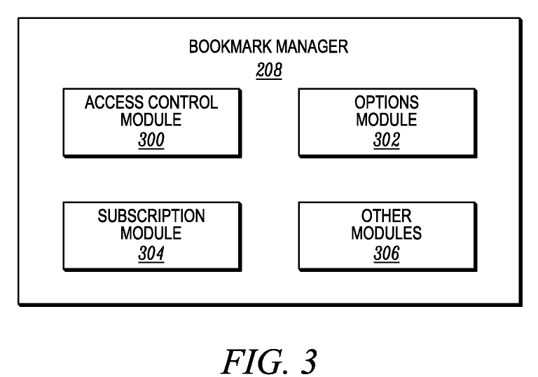

The bookmark manager 208 publishes the bookmark to be accessed by users subscribed to the bookmark server 106. The bookmark manager 208 controls the access to the bookmark, thereby protecting the copyright of the content associated with the bookmark. The bookmark manager 208 also provides various options to the users who want to access various bookmarks published on the bookmark server 106. The bookmark manager 208 is explained in detail later with reference to FIG. 3.

The synchronization module 210 activates when the bookmark clipper 206 identifies the content source 104 to be a broadcast channel. In such a case, there can be a time shift between a program received by the remote device 102-1 from the broadcast channel and the same program received by the bookmark server 106 from the same broadcast channel. Such a time shift can occur due to variation in services provided by different service providers. For example, the remote device 102-1 may be receiving a channel X from a direct-to-home (DTH) service A, and the bookmark server 106 may be receiving the channel X from a cable service B. There is a possibility that transmission delay in the DTH service A is lower than that in the cable service B, therefore, the bookmark server 106 receives a program from the channel X with a time lag as compared to the remote device 102-1. The synchronization module 210 ensures that the bookmark clipper 206 extracts the correct portion of program by synchronizing with the remote device 102-1. The synchronization module 210 communicates with the remote device 102-1 to identify the time shift. The synchronization module 210 identifies the time shift by employing one or more video analyzing techniques known in the art. The synchronization module 210 determines the start time, also referred to as first time, of the portion of the content as provided in the metadata. The synchronization module 210 then determines a second time at which the bookmark server 106 receives the same portion of the content.

The synchronization module 210 determines a time shift based on the difference between the first time and the second time. The synchronization module 210 communicates the time shift to the bookmark clipper 206, thereby enabling the bookmark clipper 206 to extract the relevant portion of the content from the program broadcasted by the broadcast channel.

FIG. 3 is a block diagram of the bookmark manager 208 included in the bookmark server 106. In one embodiment, the bookmark manager 208 includes an access control module 300, an options module 302, a subscription module 304, and other modules 306 that may support functioning of the other three modules.

The access control module 300 controls access to the bookmark server 106 and bookmarks published on the bookmark server 106. A user can access the bookmark server 106 to either request the bookmark server 106 to create a bookmark or to access the published bookmarks. The bookmark server 106 requires that the user subscribe to the bookmark server 106 to gain access. The access control module 300 authenticates the user before granting access to the bookmark server 106. The access control module 300 may verify credentials of the user based on one or more authentication parameters such as a username, a password, or a personal identification number (PIN), and the like. In one embodiment, the user and the bookmark server 106 mutually authenticate each other, where the user identifies the bookmark server 106 based on a server ID, and the like.

The access control module 300 also maintains copyright protection of content associated with the bookmarks by restricting any unauthorized access to the bookmark. The access control module 300 enforces certain access policies on each of the published bookmarks. The access policies may apply independently to the metadata and the content associated with the bookmark. A user who creates a bookmark may enforce access policies and impose restrictions for the metadata, and the content source 104 enforces access policies and imposes restrictions for the content associated with the bookmark. It may be possible for a subscribed user to access the metadata of the bookmark, but is restricted to access the content associated with the bookmark. The access control module 300 can allow access to the content associated with the bookmark, if the bookmark server 106 has a right to distribute the content from the content source 104. In case the content source 104 is a broadcast channel, the access control module 300 allows a subscribed user to view all the bookmarks created from the programs broadcasted by the broadcast channel. The access control module 300 works in conjunction with the options module 302 to ensure access control for the bookmarks suggested by the options module 302 to a user, as described in detail below.

The options module 302 provides the user with various options or alternatives if the user is unable to access a desired bookmark. It may be possible that the user has rights to access the metadata associated with the desired bookmark but does not have rights to the content associated with the bookmark. In such a case, the options module 302 can provide various options for finding relevant content or alternative content for which the user has access rights. Relevant and alternative content can have various definitions and interpretations.

In one example, relevant content refers to the same content as that of the desired bookmark, obtained through a different service provider but from the same content source. For example, relevant content for a bookmark having content from the movie “Jurassic Park”, originally obtained from a channel X through a service provider A can be the same content from the movie “Jurassic Park” obtained from the channel X through another service provider B. Relevant content may also refer to the same content as that of the desired bookmark, but of lower or inferior quality.

Similarly, in one example, alternative content refers to content having similar metadata as that of the desired bookmark. For example, alternative content for the desired bookmark having content from the movie “Jurassic Park” can be content from the movie “Jurassic park-III”. Alternative content may be received from either same or different content source. Alternative content may also refer to content from other bookmarks of the same user who created the desired bookmark. Alternative content may also refer to any content determined to be appropriate by the bookmark server 106 based on the metadata of the desired bookmark.

The options module 302 can also provide an option of deferring the search for the content of the desired bookmark. In one embodiment, if the options module 302 fails to find any relevant or alternative content, the options module 302 defers or postpones the search for the content of the desired bookmark for a later period. Whenever the content is available, the options module 302 records the content and provides the user with the content. For example, if the user cannot find “Jurassic Park”, but the same is available next day, the options module 302 schedules the recording for the relevant content for the user.

The subscription module 304 allows a user to subscribe to a broadcast channel when desired. The user after watching a portion of content from a bookmark may want to watch the entire content. The subscription module 304 enables the user to subscribe to a broadcast channel broadcasting a program from where the content was extracted. In one embodiment, the subscription module 304 may allow the user to subscribe to the broadcast channel on a pay per view basis. In such a case, the user can pay only for the program he desires to watch and not for the entire channel. However, such a subscription would be subjected to terms and conditions of the broadcast channel.

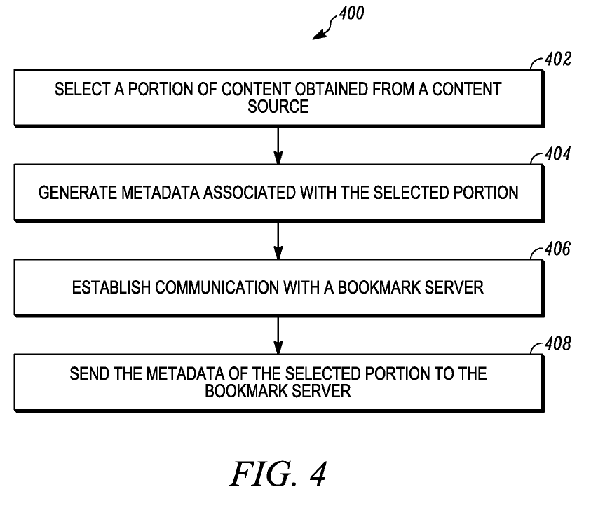

FIG. 4 shows a flowchart 400 of a method for facilitating a remote device to send metadata to create a bookmark. The flowchart 400 has been explained in reference to FIG. 1 and FIG. 2. At step 402, a remote device, for example, the remote device 102-1, selects a portion of content obtained from a content source, for example, the content source 104. In one embodiment, the content source 104 is either a pre-recorded audio-video source or a broadcast channel. The remote device 102-1 selects a portion of the content based on an input received from a user. The remote device 102-1 has the capability to rewind and forward the content, thus enabling the user to select a desired portion of the content playing on the remote device 102-1.

At step 404, the remote device 102-1 generates metadata associated with the selected portion of the content. In one embodiment, the metadata include, but not limited to, content source information, EPG information, start time, duration of the portion of the content and content description. The user can also append the metadata with any customized information, as desired.

At step 406, the remote device 102-1 establishes a communication with the bookmark server 106. The communication may be routed via the network 108. To establish the communication, the remote device 102-1 requires mutual authentication with the bookmark server 106. The bookmark server 106 prompts the remote device 102-1 to enter authentication parameters such as username, password, etc.

At block 408, after establishing the communication, the remote device 102-1 sends the metadata generated in step 404 to the bookmark server 106. The remote device 102-1 sends the metadata along with a request message to the bookmark server 106 to create a bookmark based on the metadata.

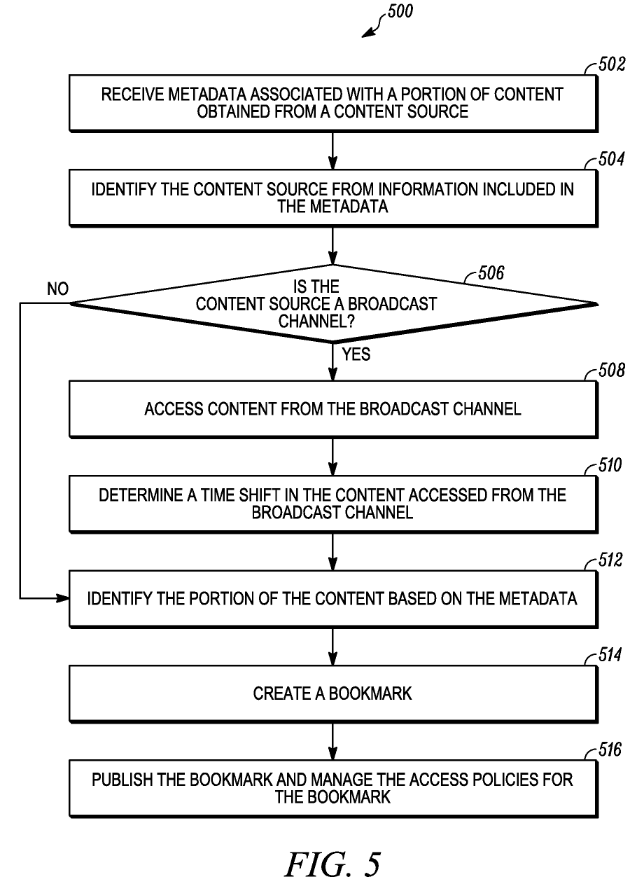

FIG. 5 shows a flowchart 500 of a method for facilitating a bookmark server to create a bookmark. The flowchart 500 is explained in reference to FIG. 1. At step 502, the bookmark server 106 receives metadata generated by the remote device 102-1 for content obtained from the content source 104. The remote device 102-1 may send the metadata along with a request message for creating a bookmark.

At step 504, the bookmark server 106 analyzes the metadata and determines that the content is obtained from the content source 104. The bookmark server 106 also determines the type of the content source 104, i.e. either a pre-recorded audio-video source or a broadcast channel.

At step 506, the bookmark server 106 determines whether the content source 104 is a broadcast channel. In one embodiment, if the bookmark server 106 determines that the content source 104 is a broadcast channel, the bookmark server 106 follows instructions at step 508. On the other hand, if the content source is not a broadcast channel, the bookmark server 106 follows instructions at step 512.

At block 508, the bookmark server 106 accesses the content from the broadcast channel. In one embodiment, the bookmark server 106 is subscribed to the broadcast channel and stores current program broadcasted by the broadcast channel in a buffer.

At block 510, the bookmark server 106 determines a time shift in the content accessed from the broadcast channel. In one embodiment, the bookmark server 106 communicates with the remote device 102-1 to determine any time shift between the content received by the remote server 102-1 and the content received by the bookmark server 106 from the same broadcast channel. The bookmark server 106 employs one or more video analyzing techniques for determining the time shift.

At step 512, the bookmark server 106 identifies the portion of the content from the content source 104 based on the metadata. In case the content source 104 is a pre-recorded audio-video source, the bookmark server 106 searches a database for the content obtained from the pre-recorded audio-video source and after obtaining the content, the bookmark server 106 identifies and extracts the portion of the content based on the information included in the metadata. However, if the content source 104 is a broadcast channel, the bookmark server 106 accesses the broadcast channel to obtain the content. After obtaining the content, the bookmark server 106 identifies and extracts the portion of the content based on the information included in the metadata and the determined time shift.

At step 514, the bookmark server 106 creates a bookmark. In one embodiment, the bookmark server 106 creates a bookmark by including at least the metadata associated with the portion of the content. The bookmark server 106 may also include the extracted portion of the content in the bookmark depending upon access policies dictated by the content source 104 or by a user who creates the bookmark. In an alternate embodiment, the bookmark server 106 includes a link to the portion of the content along with the metadata in the bookmark.

At step 516, the bookmark server 106 publishes the bookmark and manages the access policies of the bookmark. In one embodiment, the bookmark server 106 publishes the bookmark on a website that is accessible by users subscribed to the bookmark server 106. After publishing the bookmark, the bookmark server 106 manages the access policies for the bookmark to ensure copyright protection of the content associated with the bookmark.

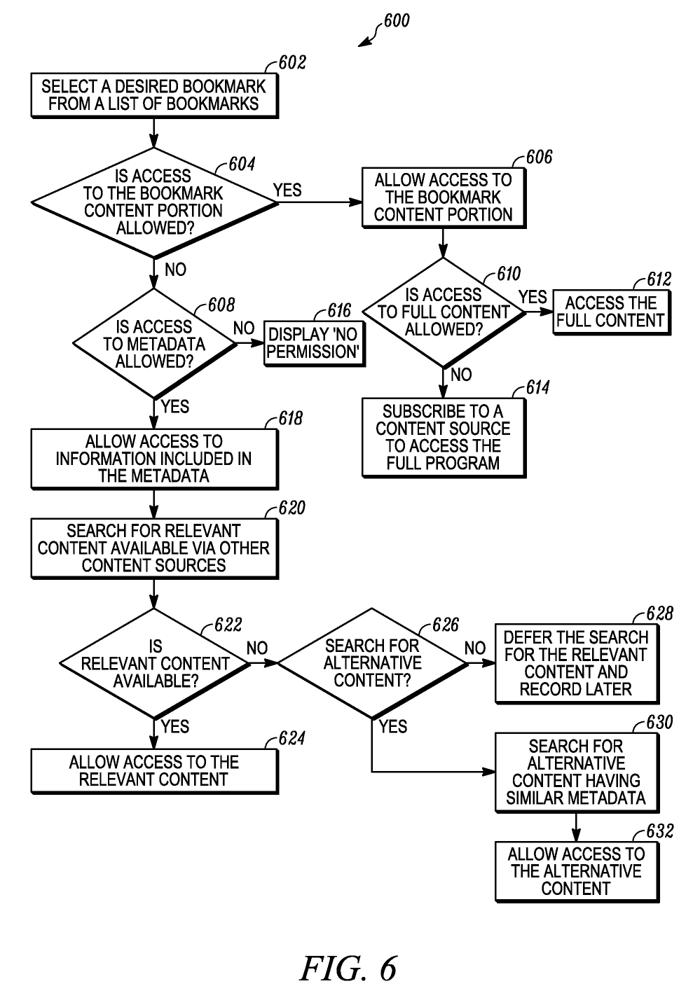

FIG. 6 shows a flowchart 600 of a method for accessing a bookmark published on a bookmark server. The flowchart 600 has been explained with reference to FIG. 1. At step 602, a user selects a desired bookmark from a list of bookmarks on the bookmark server 106. In one embodiment, the bookmark server 106 maintains a large collection of bookmarks created by various users subscribed to the bookmark server 106. The bookmark server 106 may maintain one or more lists of the bookmarks based on bookmark creator, bookmark creation date, bookmark genre, etc. A user subscribed to the bookmark server 106 can access the bookmark server 106, which presents a graphical user interface on a remote device possessed by the user. The user can then select any one of the bookmarks from the one or more lists of the bookmarks presented through the graphical user interface of the bookmark server 106.

At step 604, the bookmark server 106 determines whether access to content portion associated with the selected bookmark is allowed. In one embodiment, the bookmarks listed in the bookmark server 106 have different access policies governing them. A user-1 may be allowed to access bookmarks created by a user-2, but denied to access bookmarks created by a user-3. There can be several other access policies based on which access to a bookmark is determined. The bookmark server 106 therefore determines whether access to content portion associated with the bookmark selected by the user is allowed or not. If the bookmark server 106 determines that the access is to be allowed, then the bookmark server 106 follows instructions at step 606. On the other hand, if the bookmark server 106 determines that the access is not allowed, then the bookmark server 106 follows instructions at step 608.

At step 606, the bookmark server 106 allows access to the content portion associated with the selected bookmark. In one embodiment, upon determining the access policies of the bookmark, the bookmark server 106 allows the user to access the content portion associated with the bookmark. The bookmark server 106 allows the access to the content after ensuring the copyright protection of the content, i.e. the bookmark server 106 has obtained rights from a content source from where the content is obtained.

At block 610, the bookmark server 106 determines whether the access to the full content is allowed. In one embodiment, the bookmark server 106 asks the user if the user desires access to the entire content or not. In case the user wishes to access the entire content, the bookmark server 106 determines whether the user has access to the full content. If the user has the access to the full content, based on access policies or subscription, the user is allowed access to the full content, as shown in step 612. However, if the user does not have access to the full content, then the bookmark server 106 asks the user to subscribe to a content source from which the content is obtained, as shown in step 614. Upon subscribing to the content source, the user may access the full content as well as other programs content available through the content source.

At step 608, upon determining that access to the content portion is not allowed to the user, the bookmark server 106 further determines whether access to metadata associated with the bookmark allowed to the user. If access to the metadata is not allowed, the bookmark server 106 displays a message stating no permission to access the bookmark, as shown in step 610. However, if the bookmark server 106 determines that access to the metadata is allowed, then the bookmark server 106 follows instructions at step 612.

At step 612, the bookmark server 106 allows the user to access information included in the metadata associated with the bookmark selected by the user. The bookmark server 106 presents the information on the graphical user interface in a format readable by the user. The information in the metadata can include content source identity, content description, duration of the content, size and format of the content, and the like.

At step 614, the bookmark server 106 searches for relevant content via other content sources. In one embodiment, the bookmark server 106 searches for relevant content based on the metadata of the bookmark. The bookmark server 106 can obtain the relevant content from other content sources to which the user is subscribed. The bookmark server 106 can also obtain the relevant content from other bookmarks stored in the bookmark server 106, if the user has access to content portion of the other bookmarks.

At step 616, the bookmark server 106 determines whether the relevant content is available. In one embodiment, the bookmark server 106 searches through all available options to find the relevant content. After searching completely, the bookmark server 106 determines if any search result provides the relevant content. If the relevant content is found, the bookmark server 106 allows the user to access the relevant content, as shown in step 618. Otherwise, the bookmark server 106 follows instructions at step 620.

At step 620, the bookmark server 106 determines whether search for alternative content is to be made. In one embodiment, if the bookmark server 106 fails to find the relevant content, then the bookmark server 106 asks the user whether to search for alternative or similar type of content based on the metadata. If the user approves the search for the alternative content, the bookmark server 106 follows instructions at step 622. If the user denies the search for the alternative content, the bookmark server 106 follows instructions at step 626.

At step 622, the bookmark server 106 searches for the alternative content. In one embodiment, the bookmark server 106 searches for the alternative content based on the metadata. The bookmark server 106 searches for the alternative content in different content source, other users' bookmarks based on information such as content genre, bookmark creator, and other such parameters included in the metadata. The bookmark server 106 makes an extensive search and displays search results to the user. Validity of the search results for the alternative content is subjected to the user's discretion. The user may or may not want to access the alternative content proposed by the bookmark server 106.

At step 624, the bookmark server 106 allows the user to access to the alternative content. In one embodiment, the bookmark server 106 asks the user to select any of the alternative content from the search results. The user selects a desired alternative content. The bookmark server 106 allows the user to access the desired alternative content.

At step 626, upon failing to find the relevant content, the bookmark server 106 defers the search for relevant content for a later time and records the relevant content when available. The bookmark server 106 may refer an electronic programming guide for various broadcast channels it can access to check if the relevant content is available in near future. The bookmark server 106 can then accordingly schedule a recording for the relevant content and present it to the user, as desired.

In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

We claim:

1. A method for facilitating a bookmark server to create a bookmark from content associated with a content source, the method comprising:
selecting a portion of the content associated with the content source, based on an input from a user interface;
generating metadata associated with the selected portion of the content;
communicating with the bookmark server, the bookmark server having an access to the content associated with the content source; and
sending the metadata to the bookmark server to enable the bookmark server to create the bookmark, the bookmark comprising the metadata.

2. The method of claim 1, further comprising tracking a start time and duration associated with the selected portion of the content.

3. The method of claim 1, further comprising appending the metadata with customized information provided via the user interface.

4. The method of claim 1, further comprising authenticating the credentials of a user based on one or more authentication parameters.

5. The method of claim 1, wherein selecting a portion of the content associated with the content source comprises obtaining the content from a broadcast channel broadcasting the content to at least a remote device and the bookmark server.

6. The method of claim 1, wherein sending the metadata to the bookmark server to enable the bookmark server to create the bookmark, the bookmark further comprising the selected portion of the content.

7. A bookmark server comprising:
one or more network interfaces configured to communicate with at least a content source and a remote device, the one or more network interfaces receiving metadata comprising information related to a portion of content associated with the content source;
a bookmark clipper configured to:
identify the portion of the content by accessing the content source, based on the received metadata;
create a bookmark comprising the received metadata; and
a bookmark manager configured to manage access rights for the metadata of the bookmark.

8. The bookmark server of claim 7, wherein the metadata comprise a start time and duration associated with the portion of the content.

9. The bookmark server of claim 7, wherein the bookmark further comprises the identified portion of the content.

10. The bookmark server of claim 9, wherein the bookmark manager comprises an access rights module configured to control access to the content portion of the bookmark based at least on restrictions imposed by the content source.

11. The bookmark server of claim 7, wherein the bookmark manager is further configured to control access to the metadata associated with the bookmark based at least on restrictions imposed by a user.

12. The bookmark server of claim 9, wherein the bookmark manager further comprises an options module configured to provide an option to access the content portion of the bookmark from a different content source.

13. The bookmark server of claim 12, wherein the options module is further configured to search for alternative content based on the metadata of the bookmark.

14. The bookmark server of claim 12, wherein the options module is further configured to defer a search for the content portion of the bookmark, and to optionally record the content portion when available.

15. The bookmark server of claim 9, wherein the bookmark manager further comprises a subscription module configured to subscribe to the content source to access the content portion of the bookmark.

16. The bookmark server of claim 7, wherein the content is obtained from a broadcast channel broadcasting the content to at least the remote device and the bookmark server.

17. The bookmark server of claim 16, further comprising identifying a time shift, between a first time associated with the content as received by the remote device from the broadcast channel and a second time associated with the content as received by the bookmark server from the broadcast channel.

18. A method of creating a bookmark on a bookmark server, the method comprising:
receiving metadata related to a portion of content associated with a content source;
accessing the content from the content source based on the metadata;
identifying the portion of the content based on the metadata;
creating the bookmark, the bookmark comprising the metadata; and
publishing the bookmark to provide access to the bookmark to viewers subscribed to the bookmark server.

19. The method of claim 18, further comprising communicating with the content source to access the content.

20. The method of claim 18, further comprising authenticating a user creating the bookmark based on one or more authentication parameters.

21. The method of claim 18, wherein accessing the content from the content source comprises obtaining the content from a broadcast channel broadcasting the content to at least a remote device and the bookmark server.

22. The method of claim 21, further comprising identifying a time shift, between a first time associated with the content as received by the remote device from the broadcast channel and a second time associated with the content as received by the bookmark server from the broadcast channel.

23. The method of claim 18, wherein creating the bookmark further comprises including the identified portion of the content in the bookmark.

24. The method of claim 23, further comprising managing access rights for the metadata and the content portion associated with the bookmark.

25. The method of claim 18, further comprising accessing alternative content from one or more content sources based on the metadata.
